(19) United States
(12) Patent Application Publication
(10) Pub. No.: US 2006/0080079 A1
(43) Pub. Date: Apr. 13, 2006

(54) Translation system, translation communication system, machine translation method, and medium embodying program

(75) Inventor: Kiyoshi Yamabana, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation

(21) Appl. No.: 11/235,333

(22) Filed: Sep. 27, 2005

(30) Foreign Application Priority Data
Sep. 29, 2004 (JP) 282866/2004

(51) Int. Cl. G06F 17/28

(52) U.S. Cl. 704/2

(57) ABSTRACT

A translation means determination section of a translation system determines whether translation processing of language data input from an input section is to be performed in an internal translation section or on an external translation server connected by a communication line through a communication control section. In the latter case, it is also determined what processing the translation server is requested to perform. The translation means determination section flexibly switches between internal processing and processing on the translation server by using information such as a language pair to which translation is applied, the communication line state, and a comparison of abilities between the translation system and the translation server. A translation result of the translation section is output from an output section. This configuration allows easy implementation of function extension viewed from a user while minimizing communication cost and overhead.

### BACKGROUND OF THE INVENTION

1. Field of the Invention

The present invention relates to a translation system, a translation communication system, a machine translation method, and a medium embodying a program. More particularly, the present invention relates to a translation system, a translation communication system, a machine translation method, and a medium embodying a program in which a determination is made as to whether translation processing is to be performed in a translation section of a terminal or performed on a translation server.

2. Description of the Related Art

Translation between languages requires a mass storage device for language knowledge databases such as dictionaries, and high computing power for resolving ambiguity in natural languages. Further, adding supported languages requires additional dictionaries and other computer resources. To perform translation or to allow addition of supported languages even with limited available resources, such as in small portable devices, various contrivances have been made.

With reference to FIG. 15, Japanese Patent Laid-Open No. 1-95650 discloses a translation communication system including: translation communication terminals 1a, 1b, 1n having only part of functions required for translation communication; complex communication processing apparatus 2a and 2b that relay communication through communication lines so that the translation communication terminals 1a, 1b, . . . , 1n can perform translation communication with each other; and central translation systems 3a, 3b, . . . , 3n.

In this translation communication system according to the Japanese Patent Laid-Open No. 1-95650, before translation communication, the translation communication terminals 1a, 1b, . . . , 1n sends information about a configuration of their speech translation functions to the central translation systems 3a, 3b, . . . , 3n through the complex communication processing apparatus 2a or 2b. Having received the information, the central translation systems 3a, 3b, . . . , 3n performs translation communication by compensating for speech translation functions that are lacking in the translation communication terminals 1a, 1b, . . . , 1n by themselves. This configuration allows speech translation communication to be performed between the translation communication terminals 1a, 1b, . . . , 1n having only part of speech translation components such as a speech recognition function, a translation function, and a speech synthesis function.

The role of each of the translation communication terminals 1a, 1b, . . . , 1n is fixed, and the central translation systems 3a, 3b, . . . , 3n always take the role of compensating for the functions lacking in the translation communication terminals 1a, 1b, . . . , 1n. Thus, the translation communication system according to the patent document 1 has an advantage that even the translation communication terminals 1a, 1b, . . . , 1n, which have only part of functions due to the lack of computer resources, can perform speech translation communication with each other like terminals having all speech translation functions.

### SUMMARY OF THE INVENTION

A translation system includes:

one or more translation sections that perform translation processing between languages;

a communication control section that controls communication with one or more translation servers through a communication line; and

a translation means determination section that determines whether to perform translation processing in the translation sections or to delegate translation processing to the translation servers through the communication control section.

A machine translation method includes:

receiving source language data;

determining in which of one or more translation sections of a terminal to perform translation processing or determining whether to delegate translation processing to one or more translation servers through a communication line;

based on the determination, performing the translation processing of the source language data on the terminal, or delegating the translation processing of the source language data to the translation servers and receiving a result; and

outputting target language data as a translation result.

A machine translation method includes:

receiving source language data;

determining whether to perform translation processing on a terminal or determining to which of a plurality of external translation servers connected through a communication path to delegate translation processing;

based on the determination, performing the translation processing on the terminal, or delegating the translation processing of the source language data to one of the external translation servers and receiving a result; and

outputting target language data as a translation result.

A machine translation method includes:

receiving source language data;

requesting and obtaining translation server information from one or more translation servers;

based on the obtained translation server information, determining whether to perform translation processing on a terminal or determining to which of the translation servers connected through a communication line to delegate translation processing;

based on the determination, performing the translation processing on the terminal, or delegating the translation processing of the source language data to one of the external translation servers and receiving a result; and

outputting target language data as a translation result.

A signal bearing medium tangibly embodying a node program of machine-readable instructions executable by digital processing apparatus comprises the processing of:

receiving source language data;

determining whether to perform translation processing on a terminal or to delegate translation processing to a translation server through a communication line;

based on the determination, performing the translation processing of the source language data in one or more translation sections of the terminal, or delegating the translation processing of the source language data to the translation server and receiving a result; and

outputting target language data as a translation result.

A signal bearing medium tangibly embodying a node program of machine-readable instructions executable by digital processing apparatus comprises the processing of:

receiving source language data;

determining whether to perform translation processing on a terminal or to delegate translation processing to any of a plurality of translation servers connected through a communication path;

based on the determination, performing the translation processing on the terminal, or delegating the translation processing of the source language data to one of the translation servers and receiving a result; and

outputting target language data as a translation result.

A signal bearing medium tangibly embodying a node program of machine-readable instructions executable by digital processing apparatus comprises the processing of:

receiving source language data;

requesting and obtaining translation server information from a plurality of translation servers;

based on the translation server information obtained from the translation servers in the requesting and obtaining processing, determining whether to perform translation processing on a terminal or determining to which of the translation servers connected through a communication line to delegate translation processing;

based on the determination, performing the translation processing on the terminal, or delegating the translation processing of the source language data to one of the translation servers and receiving a result; and

outputting target language data as a translation result.

A translation communication system includes:

one or more translation servers with a communication line;

a translation section that performs translation processing between languages;

a communication control section that controls communication with the translation servers through the communication line; and

a translation means determination section that determines whether to perform translation processing in the translation section or to delegate translation processing to the translation servers through the communication control section.

The present invention allows easy implementation of function extension viewed from a user while minimizing communication cost and overhead. The present invention also allows performing appropriate processing according to the situation, such as by performing alternative processing possible on the translation system when communication conditions are poor.

### BRIEF DESCRIPTION OF THE DRAWINGS

The above and other objects, features and advantages of the present invention will become apparent from the following detailed description when taken with the accompanying drawings in which:

FIG. 1 is a block diagram showing a configuration of a first embodiment;

FIG. 2 is a block diagram showing a configuration of a second embodiment;

FIG. 3 is a block diagram showing a configuration of a third embodiment;

FIG. 4 is a flowchart showing operation of the first embodiment;

FIG. 5 is a flowchart showing operation of the second embodiment;

FIG. 6 is a flowchart showing operation of the third embodiment;

FIG. 7 is a block diagram showing a configuration of a first translation section of FIG. 2;

FIG. 8 is a block diagram showing a configuration of a second translation section of FIG. 2;

FIG. 9 is a flowchart showing operation of a translation means determination section of FIG. 2:

FIG. 10 is a flowchart showing operation of the translation means determination section of FIG. 3:

FIG. 11A, FIG. 11B, and, FIG. 11C are diagrams describing exemplary content of a translation request and responses in the third embodiment;

FIG. 12 is a block diagram showing an exemplary configuration in which IP addresses are used as location information in the third embodiment;

FIG. 13 is a block diagram showing a configuration of a more detailed embodiment;

FIG. 14 is a flowchart showing operation of translation means determination processing in a general control program of FIG. 13; and

FIG. 15 is a block diagram showing a configuration of related art.

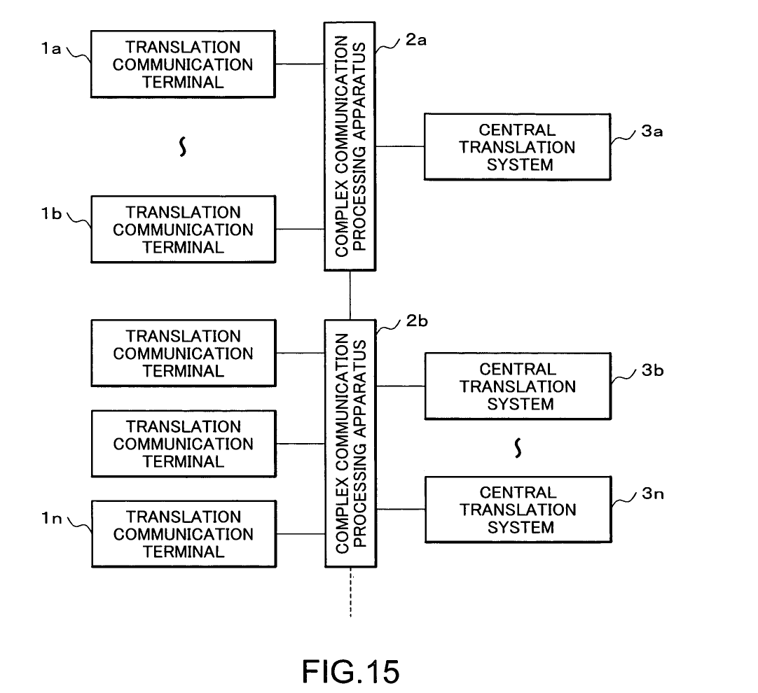

### DETAILED DESCRIPTION OF THE EXEMPLARY EMBODIMENTS

Now, a first embodiment will be described in detail with reference to the drawings.

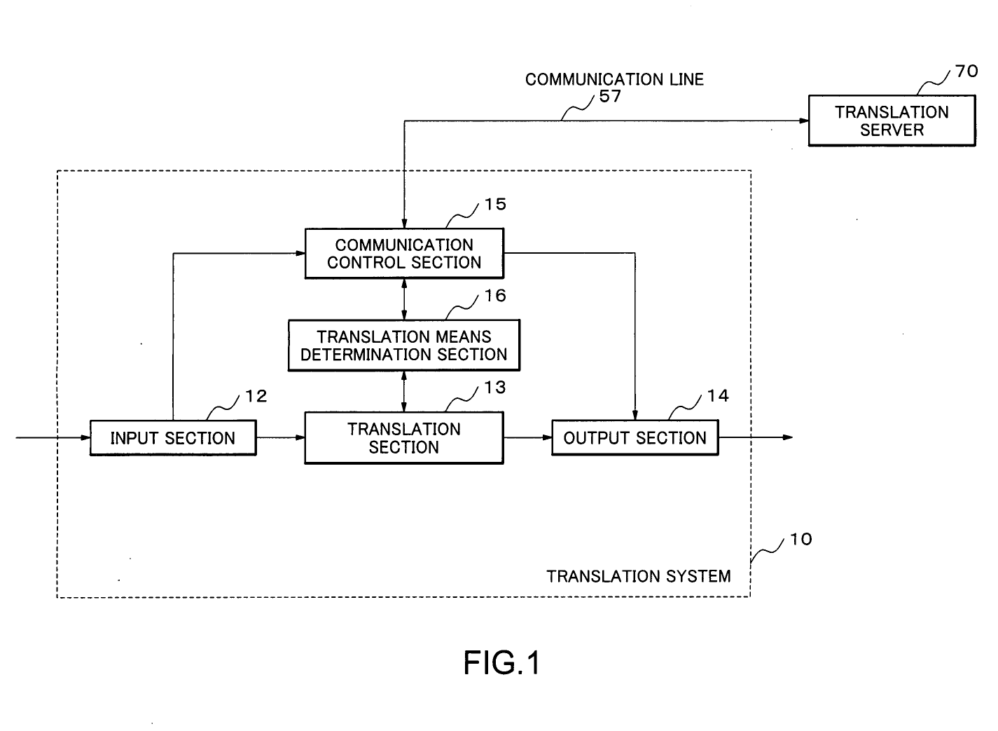

FIG. 1 is a block diagram showing a configuration of the first embodiment.

With reference to FIG. 1, a translation system 10 as the first embodiment includes an input section 12, a translation section 13, an output section 14, a communication control section 15, and a translation means determination section 16. The input section 12 receives source language input data to be translated that is input from outside. The translation section 13 translates the input source language data into a target language. The output section 14 outputs target language data as a translation result. The translation system 10 has a capability to communicate with an translation server 70 (that is external) through a communication line 57, and the communication control section 15 controls the communication between the translation system 10 and the translation server 70. The translation means determination section 16 determines whether to perform translation processing in the translation section 13 or to delegate the processing to the translation server 70 through the communication line 57.

The translation system 10 can be embodied in a computer. The computer includes a processor and a storage device (such as memory or a hard disk). The input section 12, the translation section 13, the output section 14, the communication control section 15, and the translation means determination section 16 can be implemented as a translation control program. The translation control program is stored on the storage device, and is read out and executed by the processor. The input section 12, the translation section 13, the communication control section 15, and the translation means determination section 16 can store outputs on the storage device so that they can read out and use the outputs from the storage device. Thus, the translation system 10 can perform processing by cooperation of hardware and software. This will not be expressly described hereafter.

Now, operation of the first embodiment will be described in detail with reference to the drawings.

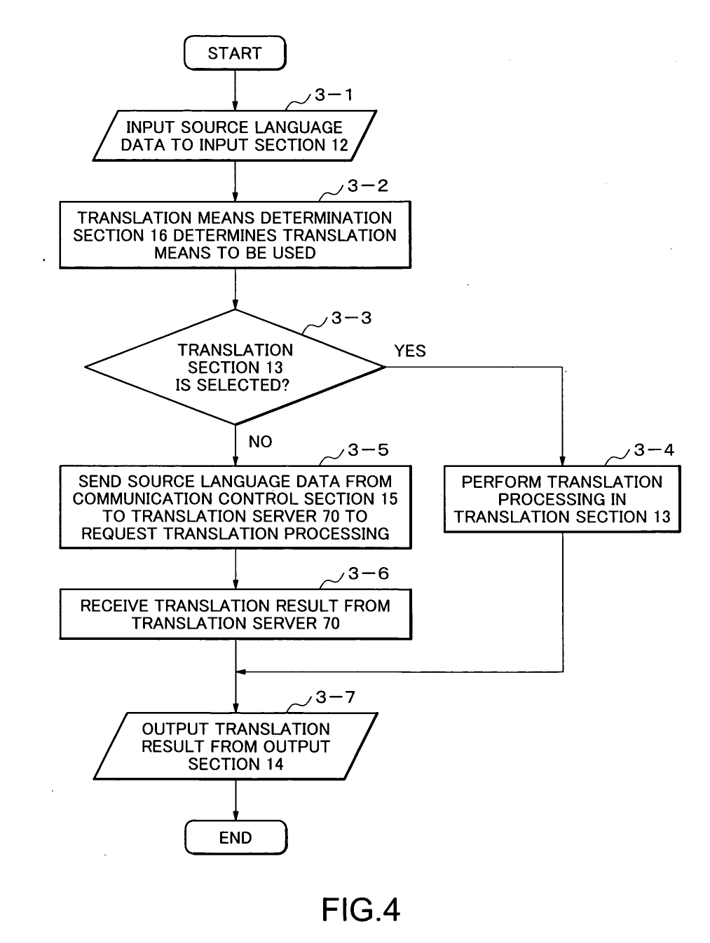

FIG. 4 is a flowchart showing operation of the first embodiment.

With reference to FIG. 4, a user first inputs source language data that they wish to have translated to the input section 12 (step 3-1 in FIG. 4). Next, the translation means determination section 16 determines whether to perform translation processing in the translation section 13 or to delegate the processing to the translation server 70 (step 3-2). If it is determined that the translation processing is to be performed in the translation section 13 (step 3-3/Yes), the input data is sent to the translation section 13 and translated into a target language (step 3-4). The translation result is sent to the output section 14 to be output to the outside (step 3-7). If the translation means determination section 16 determines that the translation processing is to be delegated to the translation server 70 (step 3-3/No), the communication control section 15 sends the input data to the translation server 70 through the communication line 57 to request the translation processing (step 3-5). The communication control section 15 receives a translation result of the translation server 70 through the communication line 57 (step 3-6). The translation result of the translation section 13 or the translation result received by the communication control section 15 from the translation server 70 is sent to the output section 14 to be output to the outside (step 3-7).

The determination logic of the translation means determination section 16 at step 3-2 may be implemented in various ways. As an example, the determination logic may select the translation section 13 if the translation language pair is supported by the translation section 13, or select the translation server 70 if the language pair is not supported by the translation section 13. This is an exemplary configuration based on a principle that the translation section 13 is used as much as possible and, if not possible, the processing is delegated to the translation server 70. Alternatively, the determination logic may be based on a principle that the translation server 70 is used as much as possible and, if not possible, the translation section 13 is used. For example, the determination logic based on this configuration may check, through the communication control section 15, whether the communication line 57 has been stably established or not. It may then determine to delegate the translation processing to the translation server 70 if the communication line 57 is stable, or to perform the processing in the translation section 13 if the communication line 57 is unstable or cannot be established. Of course, it is also possible to make the determination based on both the language pair and the communication path stability, or on other factors.

Unlike conventional art, the translation system 10 according to the present invention allows its translation means determination section 16 of the translation system 10 to make the determination of whether to perform the translation processing independently on the translation system 10 (that is local) or to delegate the processing to the translation server 70. For example, processing supported by the translation system 10 by itself may be performed on the translation system 10 as much as possible, and only processing not supported by the translation system 10 may be delegated to the translation server 70 (of center). This allows easy implementation of function extension viewed from the user while minimizing communication cost and overhead. Also, the translation system 10 that performs appropriate processing according to the situation can be provided, such as by performing alternative processing possible on the translation system 10 when communication conditions are poor.

Whether to perform the translation processing locally or on the translation server 70 is automatically determined by the translation means determination section 16. Therefore, this obviates the necessity for the user to make this determination and can reduce the burden on the user. Also, the translation means determination section 16 of the translation system 10 selects the optimal one of the translation system 10 itself and a plurality of translation servers 70 to perform or delegate the translation processing. Therefore, it can select and use the optimal translation means based on the ability, quality, cost, etc., of the translation system 10 itself and a plurality of translation servers 70. For the translation servers 70, they need not accommodate all requests from local systems but only need to answer requests that it can support and to take on the translation processing. This can reduce the cost of developing and maintaining the central systems. Further, providing a plurality of translation servers 70 by several service providers competing with each other may lead to expected enhanced usability for the user, such as advanced services, reduced costs, provision of new services beneficial to the user.

For example, a translation function for a commonly used language pair may be maintained in the translation system 10. When a translation function for a language pair other than the common language pair is needed, the translation processing is delegated to the translation server 70. That is, the translation means determination section 16 makes its determination depending on the language pair of which translation is requested: the translation processing is to be performed on the translation system 10 if the processing is supported by the translation system 10 by itself, or on the translation server 70 if otherwise. Thus, it appears for the user that an extended translation function for a language pair that the translation system 10 does not have is automatically added when it is required. Since the determination to delegate to the translation server 70 is automatically made by the translation means determination section 16, there is no burden on the user. That is, this has an advantage that required function extension is facilitated for the user. Further, since the translation processing may be delegated to the central translation server 70 as required, the cost can be reduced compared to the case where the entire extended functions are added to the translation system 10. In addition, even when poor communication conditions prevent establishing communication with the translation server 70, translation functions provided in the translation system 10 can be used without problem. Therefore, not all the translation functions are disabled in communication failure, and appropriate processing can be performed on the translation system 10 according to the situation. This is an advantage of the present invention featuring the translation system 10 with the translation means determination section 16 therein.

Alternatively, as another implementation of the translation means determination section 16, the translation processing may be performed on the translation server 70 as much as possible. If the processing cannot be delegated to the translation server 70 by any reason such as poor communication conditions, the translation processing is performed on the translation system 10. For example, the translation section 13 of the translation system 10 may be provided with a translation function as simple as looking up words in a dictionary. When communication conditions are good, the translation system 10 connects to the translation server 70 to perform high quality translation processing, while when communication conditions are poor, the translation section 13 of the translation system 10 performs simple translation processing. This has an advantage that, even in poor communication conditions, the user can be provided with a translation result according to the conditions while still maintaining the benefit of the server-based translation system 10. This is also an advantage specific to the present invention featuring the translation system 10 with the translation means determination section 16 therein.

Now, a second embodiment will be described in detail with reference to the drawings.

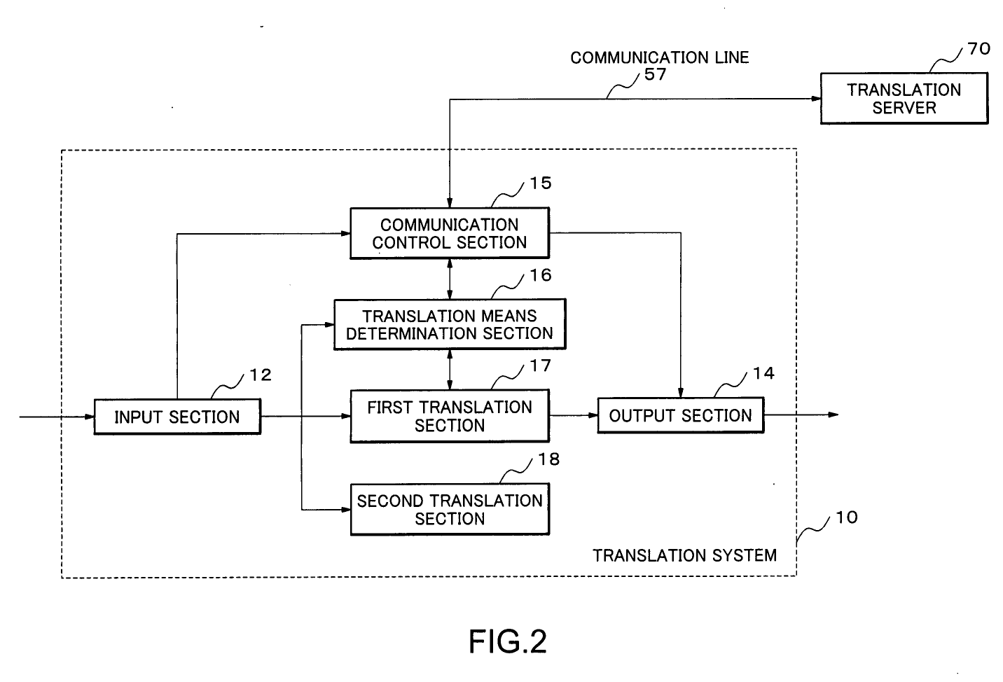

FIG. 2 is a block diagram showing a configuration of the second embodiment.

With reference to FIG. 2, the translation system 10 as the second embodiment includes the input section 12, first translation section 17, second translation section 18, the output section 14, the communication control section 15, and the translation means determination section 16. The translation system 10 has a capability to communicate with an translation server 70 through the communication line 57, and the communication control section 15 controls the communication between the translation system 10 and the translation server 70.

As with the translation system 10 of the first embodiment, the translation system 10 of the second embodiment can perform processing by cooperation of hardware and software. This will not be expressly described hereafter.

Now, operation of the second embodiment will be described with reference to the drawings.

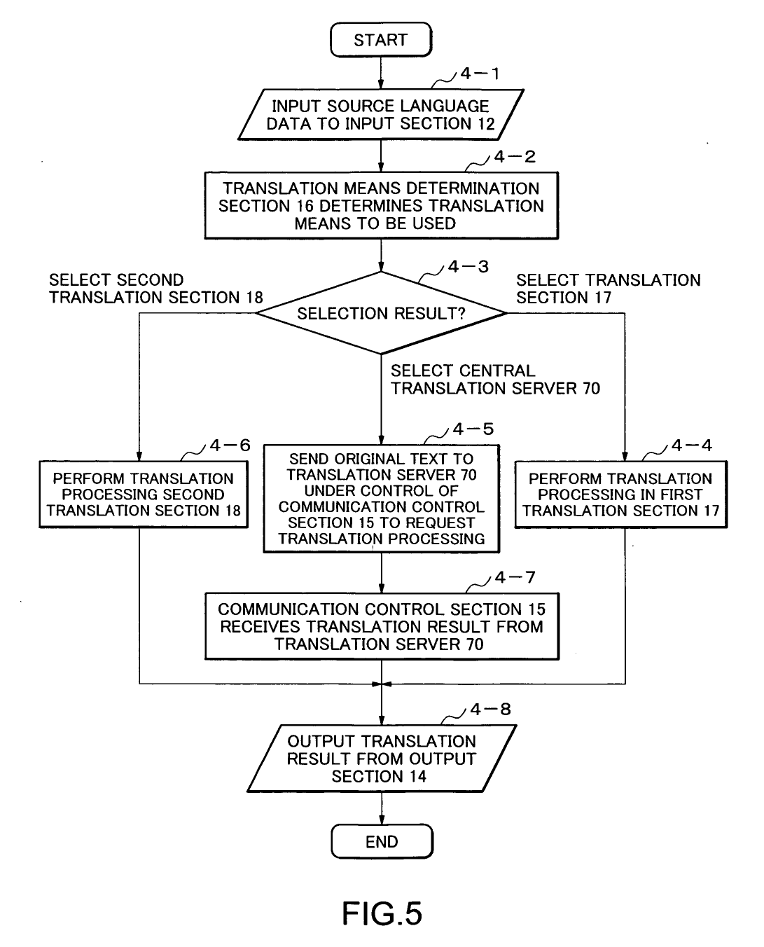

FIG. 5 is a flowchart showing operation of the second embodiment.

With reference to FIG. 5, a user first inputs source language data to be translated to the input section 12 (step 4-1 in FIG. 5). Next, the translation means determination section 16 determines whether to perform translation processing in first translation section 17 or in second translation section 18 or to delegate the processing to the translation server 70 (step 4-2). If it is determined that the translation processing is to be performed in first translation section 17 (“select first translation section 17” at step 4-3), the input data is sent to first translation section 17 and translated into a target language (step 4-4). If it is determined that the translation processing is to be performed in second translation section 18 (“select second translation section 18” at step 4-3), the input data is sent to second translation section 18 and translated into a target language (step 4-6). If it is determined that the translation processing is to be delegated to the translation server 70 (“select central translation server 70” at step 4-3), the translation system 10 sends the original text to the translation server 70 through the communication line 57 under the control of the communication control section 15 to request the translation processing (step 4-5). After the translation processing by the translation server 70, the communication control section 15 receives the result through the communication line 57 (step 4-7). The translation result obtained in this way is output from the output section 14 (step 4-8).

Thus, in the second embodiment, the translation processing is performed by first translation section 17, second translation section 18, or the translation server 70, depending on the determination made by the translation means determination section 16.

Next, first translation section 17 and second translation section 18 will be described in more detail with reference to the drawings.

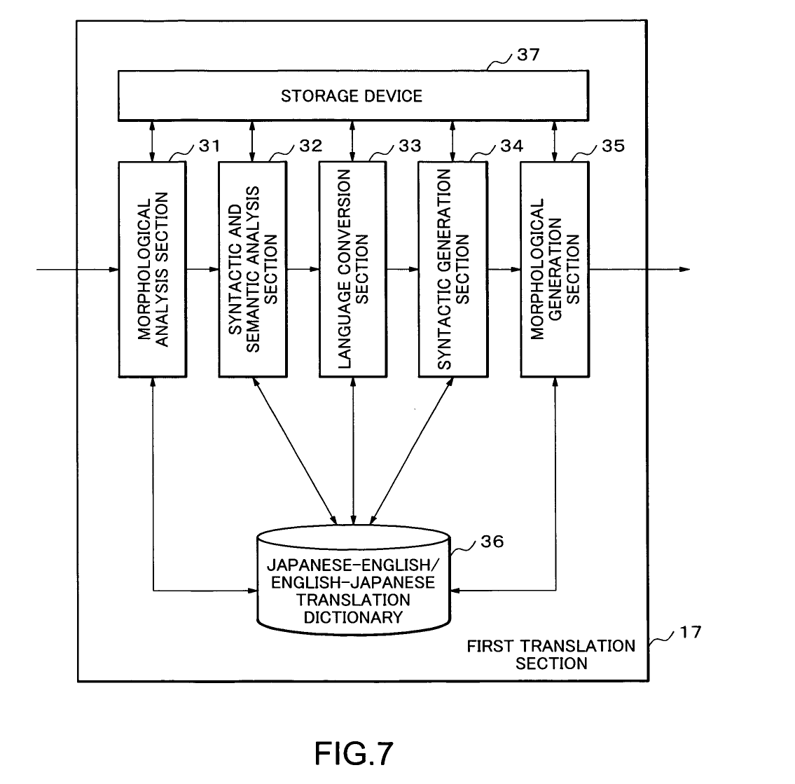

FIG. 7 is a block diagram showing a configuration of first translation section 17 in the second embodiment.

With reference to FIG. 7, first translation section 17 includes a morphological analysis section 31, a syntactic and semantic analysis section 32, a language conversion section 33, a syntactic generation section 34, a morphological generation section 35, a Japanese-English/English-Japanese translation dictionary 36, and a storage device 37. Thus, the first translation section 17 has a function of performing machine translation from Japanese into English and vice versa. First, the morphological analysis section 31 divides an input original text into morphemes and stores morpheme sequences on the storage device 37. The syntactic and semantic analysis section 32 reads the morpheme sequences from the storage device 37, performs syntactic analysis and semantic analysis, and stores the analysis result on the storage device. The language conversion section 33 reads the analysis result from the storage device 37, performs structural conversion, and stores the result again on the storage device 37. The syntactic generation section 34 reads the analysis result subjected to the structural conversion from the storage device 37, converts it into a syntactic structure of the target language, and stores it on the storage device 37. The morphological generation section 35 then reads the syntactic structure of the target language from the storage device 37, fine-tunes it at a morphemic level such as modifying inflections, and outputs a translated text. At all these processing steps, reference is made to the Japanese-English/English-Japanese translation dictionary 36 as necessary.

Instead of using the storage device 37, data transfer from the morphological analysis section 31 to the morphological generation section 35 may also be performed directly.

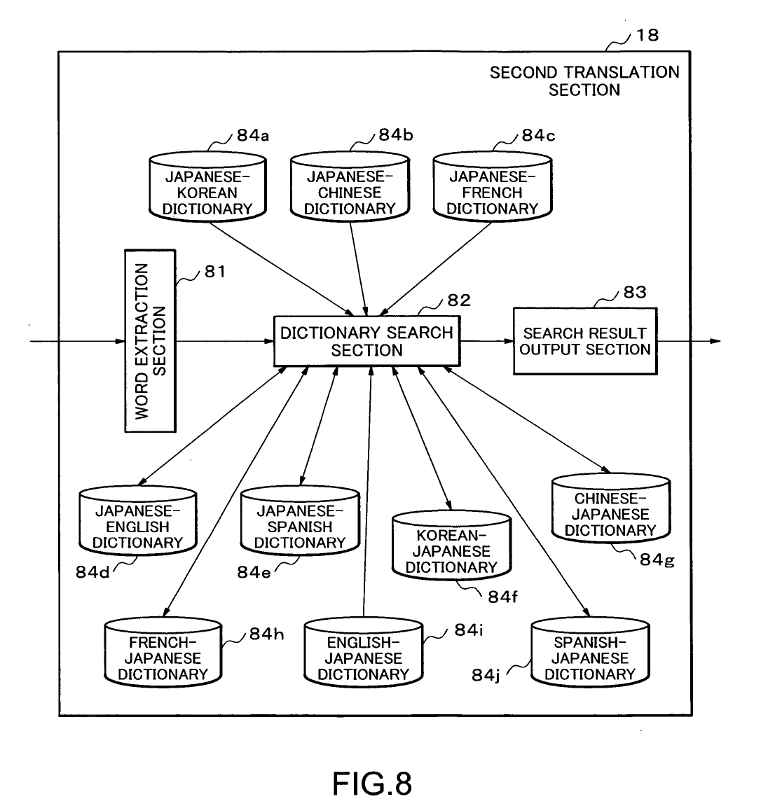

FIG. 8 is a block diagram showing a configuration of second translation section 18 in the second embodiment.

With reference to FIG. 8, second translation section 18 includes a word extraction section 81 that extracts words from an original text, a dictionary search section 82, a search result output section 83, and dictionaries searched by the dictionary search section 82. The dictionaries include a Japanese-Korean dictionary 84a, a Japanese-Chinese Chinese dictionary 84b, a Japanese-French dictionary 84c, a Japanese-English dictionary 84d, a Japanese-Spanish dictionary 84e, a Korean-Japanese dictionary 84f, a Chinese-Japanese dictionary 84g, a French-Japanese dictionary 84h, an English-Japanese dictionary 84i, and a Spanish-Japanese dictionary 84j. The word extraction section 81 detects a word or a sequence of words to be searched for, using information such as spacing between words and font type. Detection of words may also be performed by morphological analysis using a word dictionary. The words to be searched for are input to the dictionary search section 82, which searches a dictionary corresponding to a specified language pair and outputs a search result. For example, when a language pair of Japanese into English is specified and a Japanese text is input, the dictionary search section 82 searches the Japanese-English dictionary 84d by using Japanese words as keys. The search result is input to the search result output section 83, which outputs it to the outside of the second translation section 18. While the first translation section 17 performs machine translation of a sentence or a larger unit, the second translation section 18 only searches the dictionaries on word basis. The processing of the second translation section 18 involves a lighter workload than the processing of the first translation section 17. The second translation section 18, which is basically dictionary look-up, is easier to develop than the first translation unit 17, and a new language pair can be added at a relatively low cost. Therefore, compared to the first translation section 17, more language pairs can be supported in the translation system 10. However, since the'second translation section 18 only searches the dictionaries on e word basis, it is inferior to the first translation section 17 in that it does not provide correct translation at an expression level or sentence level.

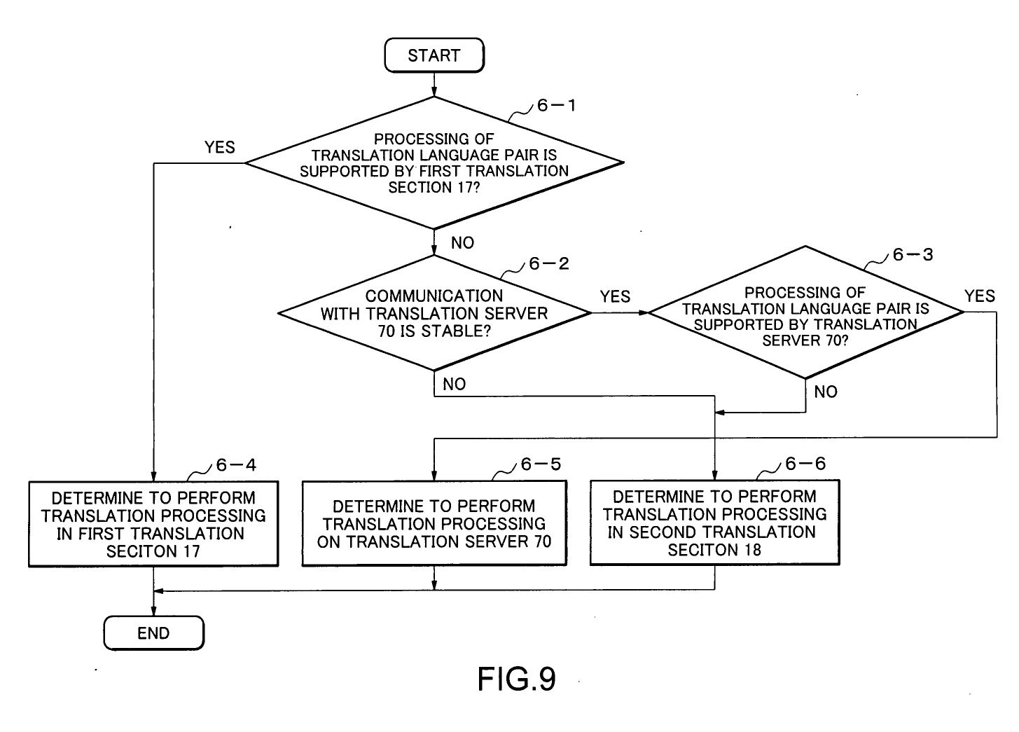

FIG. 9 is a flowchart describing operation of the translation means determination section 16 in the second embodiment.

With reference to FIG. 9, the translation means determination section 16 first checks whether translation processing of the translation language pair is supported by the first translation section 17 (step 6-1). In the configuration shown in FIG. 7, the language pairs that can be translated by first translation section 17 are Japanese into English and English into Japanese. Therefore, the translation means determination section 16 checks whether the specified language pair is one of these pairs. If processing of the language pair is supported by the first translation section 17 (step 6-1/Yes), the translation means determination section 16 determines that the translation processing is to be performed in the first translation section 17 (step 6-4). Otherwise (step 6-1/No), the translation means determination section 16 checks whether communication with the translation server 70 is stable (step 6-2). If the communication with the translation server 70 is stable (step 6-2/Yes), the translation means determination section 16 checks whether processing of the translation language pair is supported by the translation server 70 (step 6-3).

If the translation language pair is supported by the translation server 70 (step 6-3/Yes), the translation means determination section 16 determines that the translation processing is to be performed on the translation server 70 (step 6-5). If it is determined that the communication with the translation server 70 is not stable (step 6-2/No) or processing of the translation language pair is not supported by the translation server 70 (step 6-3/No), then the translation means determination section 16 determines that the translation processing is to be performed in second translation section 18 (step 6-6).

In this manner, if the local system can perform translation processing, the local system has priority to perform the processing. If not, the processing is delegated to the translation server 70. If that is also impossible, alternative translation processing is locally performed. Thus, the user can be provided with an appropriate service according to the situation. This is an advantage of the present invention.

For example, when translation processing from Japanese into English is specified, translation of this language pair is supported by first translation section 17. Then step 6-1 leads to Yes, and first translation section 17 performs the translation processing. When translation processing from Japanese into French is specified, translation of this language pair is not supported by first translation section 17. Then step 6-1 leads to No, and the translation means determination section 16 checks whether communication with the translation server 70 is stable at step 6-2. If the communication is stable, step 6-2 leads to Yes, and the translation means determination section 16 checks whether the translation server 70 supports translation processing of the language pair of Japanese into French. If so, step 6-3 leads to Yes, and the translation server 70 performs translation from Japanese into French. If the communication with the translation server 70 has not been established stably at step 6-2, second translation section 18 performs translation processing. Second translation section 18 searches the Japanese-French dictionary 84c to output the search result.

In the translation system 10, for example, the first translation section 17 may be a general machine translation section, while second translation section 18 may be a dictionary search mechanism for as many languages as possible that are not supported by the first translation section 17. The translation means determination section 16 selects the first translation section 17 for a language pair supported by the first translation section 17, or delegates the translation processing to the translation server 70 for other language pairs. However, if the translation server 70 cannot process the translation for some reason (for example, the translation server 70 cannot be accessed due to poor communication condition, is too busy to accept the request, or cannot process translation because of an unsupported language pair), then the translation means determination section 16 can request the second translation section 18 to perform processing. Since the second translation section 18 is configured with dictionary search functions for many language pairs, it can return a search result to the user in most cases. Thus, even if the translation cannot be performed by the first translation section 17 nor can be delegated to the translation server 70 for some reason, the user can be presented with information that may be helpful for translation. In other words, since the translation means determination section 16 is able to make an appropriate choice among the first translation section 17, the translation server 70, and the second translation section 18 depending on the situation, the user can be advantageously presented with appropriate information in various situations. This is an advantage of the present invention, featuring the translation system 10 with the first translation section 17, the second translation section 18, the communication control section 15 and the translation means determination section 16 therein.

Now, operation of a third embodiment will be described with reference to the drawings.

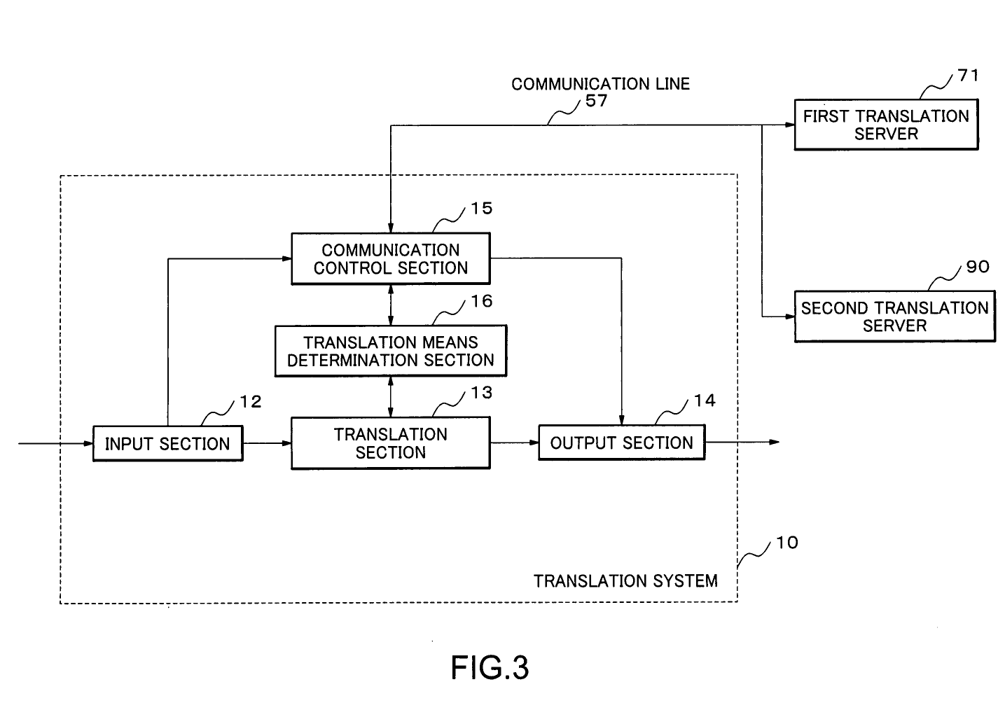

FIG. 3 is a block diagram showing a configuration of the third embodiment.

With reference to FIG. 3, the translation system 10 as the third embodiment includes the input section 12, the translation section 13, the output section 14, the communication control section 15, and a translation means determination section 16. The translation system 10 further has a capability to communicate with an external first translation server 71 and second translation server 90 through the communication line 57. The communication control section 15 controls the communication of the translation system 10 with the first translation server 71 and the second translation server 90.

Now, operation of the third embodiment will be described in detail with reference to the drawings.

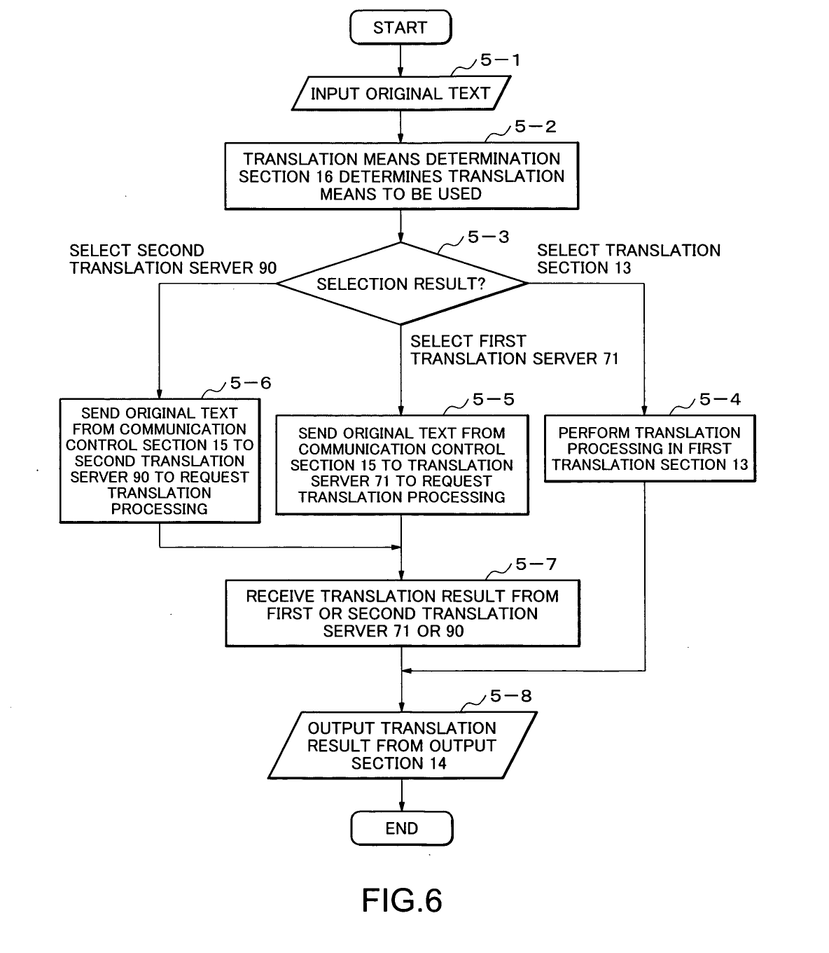

FIG. 6 is a flowchart showing operation of the third embodiment according to the present invention.

With reference to FIG. 6, when an original text is input from the input section 12 (step 5-1), the translation means determination section 16 selects among the translation section 13, an external first translation server 71, and second translation server 90 (step 5-2). If the translation section 13 is selected (“select the translation section 13” at step 5-3), the translation section 13 performs translation processing of the original text provided from the input section 12 (step 5-4). If the first translation server 71 is selected (“select first translation server 71” at step 5-3), the communication control section 15 sends the original text to the first translation server 71 to request the translation processing (step 5-5). If the second translation server 90 is selected (“select second translation server 90” at step 5-3), the communication control section 15 sends the original text to the second translation server 90 to request the translation processing (step 5-6). In the case where the translation processing is delegated to the first translation server 71 or the second translation server 90, the communication control section 15 receives a translation result (step 5-7). The translation result obtained in this way is output by the output section 14 (step 5-8).

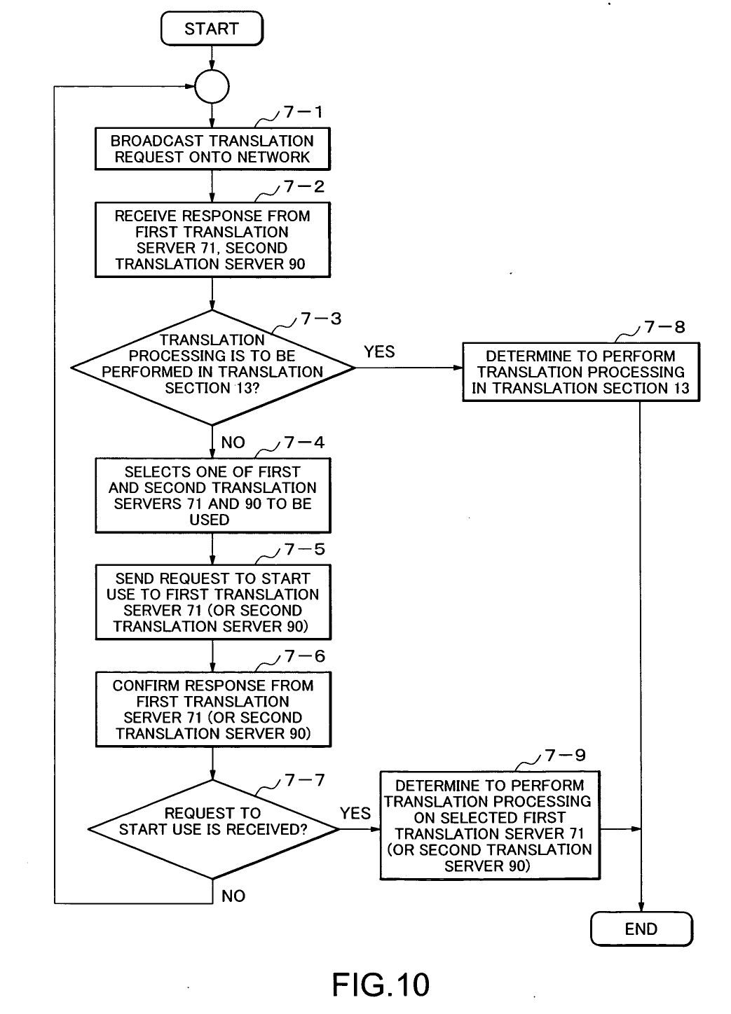

FIG. 10 is a flowchart describing the details of operation for the translation means determination section 16 to determine the translation means to be used (step 5-2) in the third embodiment.

First, the communication control section 15 broadcasts a request for translation processing onto the network through the communication line 57 (step 7-1 in FIG. 10). This broadcasted request contains a specified language pair, as well as a request to the first translation server 71 and a request to the second translation server 90. Having received the broadcasted request, the first and the second translation servers 71 and 90 return responses to the translation system 10 through the communication line 57, after they have confirmed that they can process the request (step 7-2). These responses contain information about the translation service that the first translation server 71 or the second translation server 90 can provide, such as the cost of the translation service. The responses are received by the translation means determination section 16 of the translation system 10. The translation means determination section 16 compares the ability of the internal translation section 13 with the responses from the first and the second translation servers 71 and 90 for examination. The translation means determination section 16 first determines whether to perform the translation processing in the translation section 13 or to delegate the processing to either of the first and second translation servers 71 and 90 that have returned confirmation response (step 7-3). If the translation means determination section 16 determines that the processing is to be performed in the translation section 13 (step 7-3/Yes), it takes the determination as its final determination of the translation means determination section 16 (step 7-8) and terminates its processing. If the translation means determination section 16 determines that the translation processing is to be performed in either of the first and second translation servers 71 and 90 that have returned the responses rather than in the translation section 13 (step 7-3/No), it further selects one of the first and second translation servers 71 and 90 to delegate the actual translation processing (step 7-4). In this selection, the translation means determination section 16 utilizes the service information contained in the responses from the first and second translation servers 71 and 90. Once the translation means determination section 16 has made the selection, the communication control section 15 sends a request to start actual use to the selected first translation server 71 (or second translation server 90) through the communication line 57 (step 7-5). The communication control section 15 waits for a response from the server to which it has sent the request (step 7-6) to confirm that the request to start use has been received (step 7-7). When the reception is confirmed (step 7-7/Yes), the translation means determination section 16 makes its final determination to use the selected first translation server 71 (or second translation server 90) (step 7-9) and terminates its processing. If the selected first translation server 71 (or second translation server 90) does not receive the request to start use, the processing returns to the beginning and performs the steps again from step 7-1. Thus, among the translation section 13 and the first and second translation servers 71 and 90 on the network, the optimal means for the translation processing can be selected based on various factors, such as supported language pairs and costs.

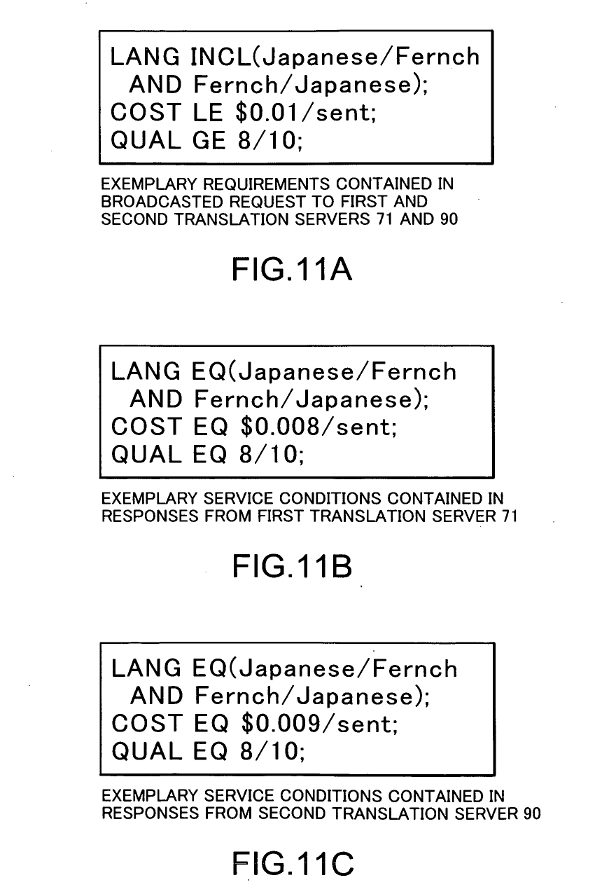

FIG. 11(a) is a diagram describing exemplary requirements for first and second translation servers 71 and 90 contained in the broadcasted message (step. 7-1 in FIG. 10).

In this example, LANG represents a requirement for translation language pairs, COST represents a requirement for the translation cost, and QUAL represents a requirement for the translation quality. Here, LANG requires that translation language pairs include Japanese-French and French-Japanese, the translation cost requires 0.01 dollars or less per sentence, and the translation quality requires 8 or more on a 1-to-10 scale. The translation quality is a value maintained in the first and second translation servers 71 and 90 for representing a measure of the translation quality. It may be evaluated in various manner, using feedback from the users or evaluation by a third party organization, for example.

FIG. 11(b) is a diagram describing exemplary available service information contained in the response from first translation server 71 to this request.

This indicates that the translation language pairs are Japanese-French and French-Japanese, the translation cost per sentence is 0.008 dollars, and the translation quality is 8 on a 1-to-10 scale.

FIG. 11(c) is a diagram describing exemplary available service information contained in the response from the second translation service 90 to the same request. This indicates that the translation language pairs are Japanese-French and French-Japanese, the translation cost per sentence is 0.009 dollars, and the translation quality is 8 on a 1-to-10 scale.

Next, operation of the translation means determination section 16 will be described in detail, where a user specifies Japanese-French translation to the translation system 10 but the translation section 13 does not have a function for Japanese-French translation.

First, the broadcasted translation request contains the information shown in FIG. 11(a) (step 7-1). The First and the second translation servers 71 and 90 on the network compare the language pairs that they can translate, the cost, and the translation quality with the broadcasted request. If they determine that the request can be satisfied, they return a response to the translation system 10. The First translation server 71 returns the information shown in FIG. 11(b), and the second translation server 90 returns the information shown in FIG. 11(c) (step 7-2). At step 7-3, the translation means determination section 16 determines whether to perform the translation processing in the translation section 13. Here, since the translation section 13 is assumed to lack a function for Japanese-French translation, the determination at step 7-3 is No. Then at step 7-4, the translation means determination section 16 selects either of the first and the second translation servers 71 and 90 to be used. First and second translation servers 71 and 90 have no difference in the language pairs that they can translate and in the translation quality. However, the cost per sentence is 0.008 dollars for the first translation server 71 while 0.009 dollars for the second translation server 90, which means the first translation server 71 is less expensive. Therefore, the first translation server 71 is selected at step 7-4. The translation system 10 then sends a request to start use to the first translation server 71 (step 7-5) and confirms the response and the reception of the request (step 7-6, then step 7-7/Yes). The translation means determination section 16 makes its final determination that the translation processing is to be performed on the first translation server 71 at step 7-9 and terminates its processing.

For the translation system 10 of the third embodiment, the service conditions contained in the responses from the first translation server 71, the second translation server 90, . . . , the nth translation server may include the above described language pairs, cost, and the translation quality. Besides these conditions, various other items may also be set as the service conditions and utilized by the translation means determination section 16. For example, first translation server 71, second translation server 90, . . . , the nth translation server may return information about a translation field they specialize in. Therefore, for example, when the translation system 10 is carried and used in a restaurant, any of the first translation server 71 to the nth translation server that specializes in translation of a restaurant field may be selected and used. When the translation system 10 is used in a hospital, any of the first translation server 71 to the nth translation server that specializes in translation of a medical field may be selected and used. In this manner, different translation servers may be used at different situations. Specifically, the user may specify a desired field, and the operation step 7-4 of the translation means determination section 16 may be adapted as follows: if any response from first translation server 71 to the nth translation server includes the user-specified field as its specialized field, the corresponding one of first translation server 71 to the nth translation server has priority to be selected. Of course, conditions may be set that do not involve specification of the cost or translation quality. Alternatively, instead of specifying conditions, the request may require particular information, and based on returned information, any of the first translation server 71 to the nth translation server may be selected to be used. For example, instead of designating specific values for the conditions of the cost and translation quality, the request may only require information about the cost and the translation quality. Obtained information may be combined and a selection may be made based on, for example, tradeoff between the cost and the translation quality. An example of information that may be utilized in selecting any of the first translation server 71 to the nth translation server besides the cost and the translation quality is location information. The translation means determination section 16 may utilize location information about the first translation server 71 to the nth translation server in making its determination. Here, the location information utilized may be virtual locations on the computer network or may be physical location information such as the longitude and latitude. As the former example, the translation means determination section 16 may utilize IP addresses as the location information. For example, the IP addresses of the first translation server 71 to the nth translation server are compared with the IP address of the translation system 10. If any of first translation server 71 to the nth translation server exists on the same LAN as the translation system 10, that translation server has priority to be selected.

This provides an advantage that, for example, when the translation system 10 is configured as a portable system and an ith translation server is installed at the current location of the system, the ith translation server may have priority to be selected and used. Specifically, for example, a dedicated ith translation server is installed at a hotel or department store. This ith translation server has a vocabulary augmented with words about services and goods, and has an improved translation quality for conversations that may take place there. The hotel or department store is provided with a wireless LAN access point accessible from inside the building, and the translation system 10 of a customer is connectable to the wireless LAN. The dedicated ith translation server is also connected to the same wireless LAN. When the user uses the translation system 10 according to the present invention at the hotel or department store, the ith translation server dedicated to this place has priority to be selected. Therefore, the user can utilize higher quality translation results for conversations that take place at the hotel or department store.

A more detailed description of the use of IP addresses as the location information will be provided with reference to the drawings.

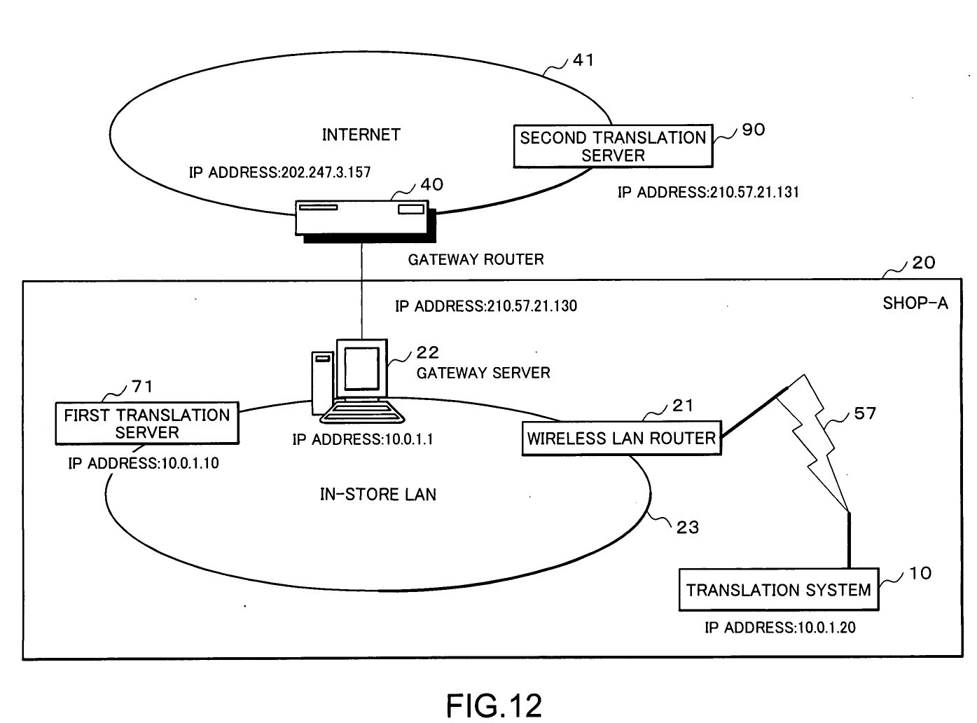

FIG. 12 is a block diagram showing an exemplary configuration in which IP addresses are used as the location information.

With reference to FIG. 12, a shop-A 20 is provided with an in-store LAN 23. First translation server 71, a gateway server 22, and a wireless LAN router 21 are connected to the in-store LAN 23. Within the in-store LAN 23, private IP addresses are assigned. First translation server 71 is assigned an IP address of 10.0.1.10, and the gateway server 22 on the in-store LAN 23 side is assigned an IP address of 10.0.1.1. The translation system 10 is in the shop and connected to the in-store LAN 23 by a wireless LAN through the wireless LAN router 21. The translation system 10 is automatically assigned an IP address of 10.0.1.20 by DHCP. The gateway server 22 is connected to a gateway router 40 on the Internet 41 through another network interface. The IP address of the gateway server 22 on the Internet 41 side is a global address, which is 202.247.3.157. The gateway router 40 has a global IP address of 210.57.21.130. The Second translation server 90, which has an IP address of 210.57.21.131, is also installed on the Internet 41.

The translation system 10 selects translation means according to the flowchart in FIG. 6. At step 5-2, a translation server at the shorter distance on the network is selected between the first translation server 71 and the second translation server 90. The distance on the network is defined such that it is shorter when two IP addresses have more matching sequential bits starting from the highest order. In the configuration in FIG. 12, the IP address 10.0.1.10 of the translation system 10 and the IP address 10.0.1.20 of first translation server 71 have 26 matching bits starting from the highest order. The IP address 10.0.1.10 of the translation system 10 and the IP address 210.57.21.131 of second translation server 90 have no matching bits starting from the highest order. Therefore, the first translation server 71 is nearer to the translation system 10 than the second translation server 90 on the network. The First translation server 71 is connected to the in-store LAN 23 of the shop-A 20 and installed in the shop-A 20. It also has enhanced translation functions with a vocabulary and expressions useful for goods sales in the shop-A 20, such as names of goods sold in the shop-A 20 and sentences that explain their selling points. The translation means determination section 16 may first give priority to the nearest one of the first translation server 71 to the nth translation server to be selected, and if no translation servers can be selected, it may then select the translation section 13. According to this configuration, the translation system 10 will automatically select the first translation server 71 when it is in the shop-A 20. Therefore, the user of the translation system 10 can be provided with an appropriate translation service for the scene where it is used.

In such an implementation, if the translation system 10 is connectable to the network and if one of the first translation server 71 to the nth translation server is found at a distance within a certain threshold, the translation system 10 may give priority to that translation server to be used. If the translation system 10 is outside the shop-A 20 and cannot connect to any LANs in the shop, the translation section 13 is selected and the translation system 10 will provide a general translation result that is not shop-specific.

Similarly, the translation means determination section 16 may utilize physical location information about the translation system 10 and the first translation server 71 to the nth translation server in making its determination. The location information about the first translation server 71 to the nth translation server may be input beforehand, for example as the latitude and longitude. The location information about the translation system 10 may be dynamically obtained such as by the Global Positioning System (GPS), or may be appropriately located and input by the user. As in the above case, the physically nearest one of the first translation server 71 to the nth translation server may be given priority to be selected, and this has an advantage that a translation server that provides the most suitable translation for the current location can be used. Again, the translation system 10 may perform translation in its own translation section 13 if it cannot connect to the network or if the nearest one of first translation server 71 to the nth translation server is beyond a certain threshold distance. Otherwise, one of the external first translation server 71 to nth translation server that is found is given priority for delegation of the translation processing.

In the first to third embodiments, the translation section 13 is not limited to a text translation section but may also be a speech translation section. The input section 12 may input speech data in a source language, the translation section 13 may perform speech translation from the source language into a target language, and the output section 14 may output speech data in the target language. The external first translation server 71 to nth translation server may have a speech translation capability. In that case, the above described configurations, operations, and advantages of the present invention also apply. Main components of speech translation, namely a speech recognition section, a machine translation section, and a speech synthesis section, may be configured to perform speech translation processing by combining processing on the translation system 10 and processing on the external first translation server 71 to the nth translation server. The translation means determination section 16 then determines where to implement each component.

When there are a plurality of translation server that provide translation functions on the network, namely first translation server 71 to the nth translation server, the ith translation server that provides the optimal function can be appropriately selected to delegate processing. For example, the first translation server 71 provides a translation function for a first language pair, and the second translation server 90 provides a translation function for a second language pair different from the first language pair. The translation system 10 may then delegate translation processing to the first translation server 71 if a language pair to be processed is the first language pair, or to the second translation server 90 if the language pair to be processed is the second language pair. Thus the present invention has an advantage that the user can be provided with various services without being limited to a service provided by a particular translation server 70.

The translation system 10 also obtains, from each of the external first translation server 71 to nth translation server, information about the translation server beforehand. The information may include supported language pairs, the cost, the translation quality, accepted domains, the network location or physical location, and so on. The translation means determination section 16 utilizes this information to determine to which of the external first translation server 71 to nth translation server to delegate translation processing. Thus the present invention has an advantage that the translation system 10 can initiatively select a server that provides higher quality translation at a lower cost and delegate processing to the selected server.

The translation system 10 initiatively and dynamically selects a server to be used among first translation server 71 to the nth translation server. Therefore, it can be expected that competition in translation services will occur among the first translation server 71 to the nth translation server on the network, and improvement in the services resulting from the competition will enhance usability for the user. This advantage of the present invention would not be achieved with a central system exclusively providing a translation function as in conventional art. Further, since the first translation server 71 to nth translation server may only have to answer requests that they can process, the cost of developing and maintaining the central servers in the present invention is greatly reduced compared to conventional art. This is another advantage of the present invention which is not present in conventional art, in which the central system is responsible for providing every function requested by any translation terminals.

Now, a more detailed embodiment of the present invention will be described with reference to the drawings.

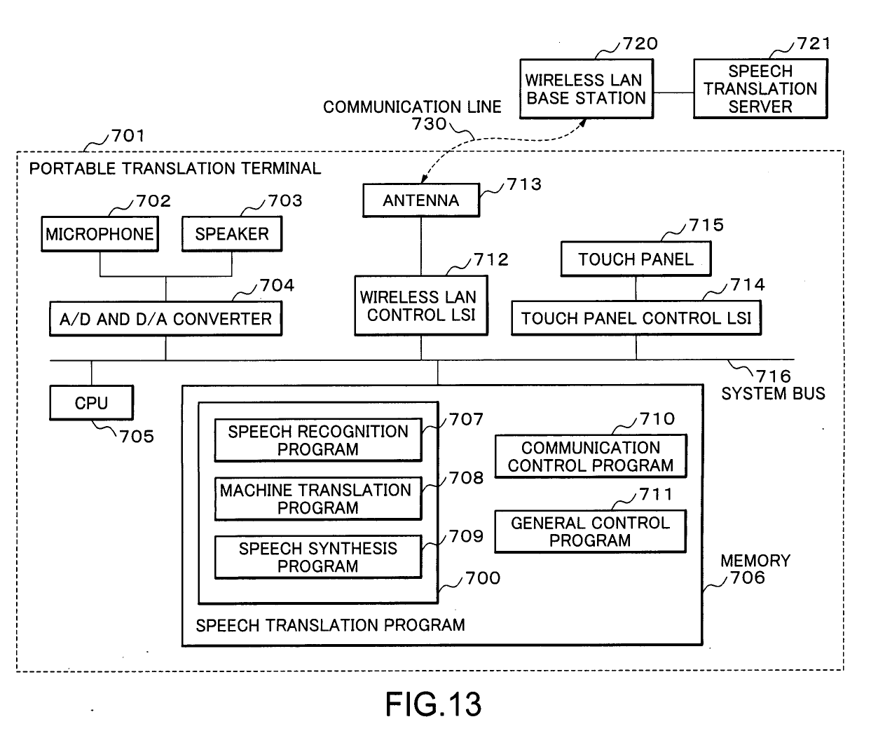

FIG. 13 is a block diagram showing a configuration of the more detailed embodiment of the present invention.

In this embodiment, the present invention is implemented as a portable translation terminal 701 with a speech translation capability from speech to speech.

With reference to FIG. 13, the portable translation terminal 701 according to the detailed embodiment of the present invention includes: a system bus 716; a microphone 702; a speaker 703; an A/D and D/A converter 704 that couples the microphone 702 and the speaker 703 to the system bus 716 of the terminal; a CPU 705; a memory 706; a wireless LAN control LSI 712; an antenna 713; a touch panel control LSI 714; and a touch panel 715 driven by the touch panel control LSI 714. A speech translation server 721 and a wireless LAN base station 720 are connected to each other through a wired LAN. The portable translation terminal 701 and the wireless LAN base station 720 are coupled to each other through a communication line 730(that is wireless).

The memory 706 stores modules corresponding to the components of the present invention as a computer program. Specifically, the memory 706 stores a speech translation program 700 (corresponding to the translation section 13), a communication control program 710 (corresponding to the communication control section 15), and a general control program 711 (corresponding to the translation means determination section 16). The speech translation program 700 includes subprograms, namely a speech recognition program 707, a machine translation program 708, and a speech synthesis program 709. These subprograms are coupled to each other to provide a speech translation capability from speech to speech as the speech translation program 700. Under the control of each subprogram, the CPU 705 performs various computations, reads from and writes to the memory 706, and controls the system bus 716 and the LSIs coupled to the system bus, thereby driving processing.

The portable translation terminal 701 of this embodiment generally operates as follows under the control of the general control program 711.

First, the case where the portable translation terminal 701 independently performs speech translation will be described.

When speech is input from the microphone 702, the A/D and D/A converter 704 converts the speech into digital data, which is then put on the system bus 716 and passed to the speech translation program 700. The digital data is first converted into a text by the speech recognition program 707 and passed to the machine translation program 708. The machine translation program 708 translates the received text into a text in a target language and passes it to the speech synthesis program 709. The speech synthesis program 709 generates digital data of read-out speech corresponding to the received text. The speech translation program 700 thus completes its processing and passes the resulting digital data of read-out speech to the A/D and D/A converter 704 through the system bus 716. The A/D and D/A converter 704 converts the received digital data of read-out speech into analog data and outputs it from the speaker 703. This sequence of speech translation processing is controlled by the general control program 711.

Various user instructions are provided through the touch panel 715, such as indicating start and stop of a speech input, specifying a translation language pair, and specifying the direction in which the translation is performed. Operations that the user performs on the touch panel 715 are conveyed as location and operation type data to the system bus 716 through the touch panel control LSI 714. The conveyed location and operation type data is interpreted by the general control program 711, so that the user instructions are implemented as appropriate changes of internal states and display content. Text information resulting from speech recognition or machine translation is sent to the touch panel 715 by the general control program 711 for display.

Next, operation in the case where translation processing is performed on the speech translation server 721 will be described.

Under the control of the general control program 711, the A/D and D/A converter 704 converts speech input from the microphone 702 into speech digital data, which is then output on the system bus 716. In parallel with the speech input and in response to the control of the communication control program 710, the wireless LAN control LSI 712 establishes a wireless LAN connection with the wireless LAN base station 720 through the antenna 713 and the communication line 730. The connection may be established after the speech translation is instructed, or in advance of the instruction. Under the control of the communication control program 710, the speech digital data is sent as a speech translation request to the speech translation server 721 through the antenna 713, the communication line 730, and the wireless LAN base station 720. The speech translation server 721 responds to the request from the portable translation terminal 701 by performing speech translation, and returns synthesized speech as a translation result through the wireless LAN base station 720 and the communication line 730. The speech data is received by the antenna 713 and passed through the system bus 716 to the A/D and D/A converter 704 under the control of the wireless LAN control LSI 712. The A/D and D/A converter 704 converts the speech data into analog data, which is output from the speaker 703. The above processing is driven by the CPU 705 operating under the control of the general control program 711 and other programs on the memory 706.

The function of the translation means determination section 16, in particular, the determination of whether to perform translation processing on the portable translation terminal 701 or on the speech translation server 721, is performed by the general control program 711. The determination may be based on a translation language pair specified by the user, a list of language pairs that the machine translation program 708 can process, stability of the communication line 730 of the wireless LAN connection checked through the communication control program 710, and so on.

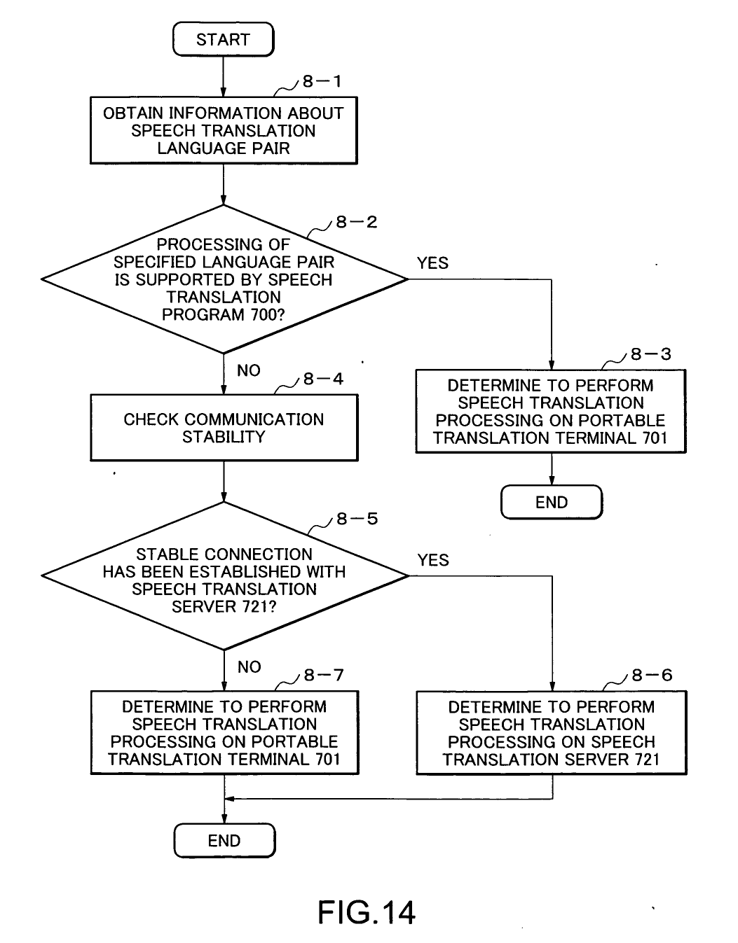

FIG. 14 is a flowchart showing how the general control program 711 determines translation processing means.

With reference to FIG. 14, the general control program 711 first obtains, through the touch panel 715, information about which translation language pair the user has specified (step 8-1 in FIG. 14). The general control program 711 then checks whether translation processing of the specified language pair is supported by the machine translation program 708 (step 8-2). If the check result is Yes, it is determined that the speech translation processing is to be performed on the portable translation terminal 701 (step 8-3), and the translation means determination processing terminates. If the check result is No at step 8-2, the communication control program 710 and the wireless LAN control LSI 712 check the communication stability at step 8-4. If it is determined that a stable connection has been established with the speech translation server 721 (step 8-5/Yes), the general control program 711 determines to delegate the speech translation processing to the external speech translation server 721 (step 8-6) and terminates its processing of translation means determination. If the determination is No at step 8-5, the general control program 711 determines to perform the speech translation processing on the portable translation terminal 701 (step 8-7) and terminates its processing of translation means determination. Thus, only if the speech translation program 700 on the portable translation terminal 701 does not support the specified language pair and if a stable connection has been established between the portable translation terminal 701 and the speech translation server 721, then the general control program 711 calls the speech translation server 721 to perform the speech translation processing. It is noted that when step 8-7 is taken, the terminal will independently perform the translation processing without support by the machine translation program 708 for the specified language pair. Therefore, attempts to do other processing will be implemented, such as speech-based dictionary lookup and example sentences search.

Besides the above described manner in which the translation means determination section 16 operates, various other manners may be contemplated. For example, it may interrogate the speech translation server 721 before the translation processing and change its operation based on the result. For example, there may be a case where both the portable translation terminal 701 and the speech translation server 721 are available for the required translation processing. Then, it is easy to interrogate the speech translation server 721 about the accuracy of its translation processing and compare the accuracy with the accuracy of the portable translation terminal 701. The processing may be performed on the one that has the higher accuracy. In that case, the speech translation server 721 should be provided with a function of responding to an interrogation about the accuracy. It is also easy to interrogate a plurality of speech translation servers 721 about their accuracy, and to delegate the actual translation processing to the one that has the highest accuracy. The interrogation is not limited to the accuracy but may be about various factors, such as speed and cost, and processing may be changed depending on the responses.

The speech translation server 721 may be a dedicated server, or may be a general-purpose computer installed on the Internet 41, wherein the general-purpose computer may receive a translation request through a public protocol and perform translation processing. In the latter configuration, the request from the portable translation terminal 701 may be widely broadcasted onto the Internet 41 rather than directed to a particular speech translation server 721, so that any speech translation servers 721 may receive the request. The portable translation terminal 701 may select the optimal one of the speech translation servers 721 that has returned a response to the request based on conditions such as their accuracy, speed, and cost, and may delegate the actual translation processing to the selected one.

While the present invention has been described in connection with certain exemplary embodiments, it is to be understood that the subject matter encompassed by the present invention is not limited to those specific embodiments. On the contrary, it, is intended to include all alternatives, modifications, and equivalents as can be included within the spirit and scope of the following claims.

What is claimes is:

1. A translation system, comprising:
one or more translation sections that perform translation processing between languages;
a communication control section that controls communication with one or more translation servers through a communication line; and
a translation means determination section that determines whether to perform translation processing in the translation sections or to delegate translation processing to the translation servers through the communication control section.

2. The translation system of claim 1, wherein
the translation means determination section makes its determination according to a language pair of which one or more of the translation sections support translation processing.

3. The translation system of claim 1, wherein
the translation means determination section makes its determination using information about a communication state with the translation servers.

4. The translation system of claim 1, wherein:
the communication control section controls communication with the translation servers through the communication line; and
the translation means determination section determines to which of the translation servers to delegate the translation processing when determining to delegate the translation processing to the translation servers.

5. The translation system of claim 4, wherein
the translation means determination section determines to which of the translation servers to delegate the translation processing using translation server information obtained from the translation servers by communicating with the translation servers.

6. The translation system of claim 5, wherein
the translation server information contains one or more of a supported translation language pair, a cost, a translation quality, and a supported domain.

7. The translation system of claim 5, wherein
the translation means determination section determines whether to perform the translation processing in the translation sections or to delegate the translation processing to the translation servers through the communication control section by obtaining the translation server information containing, network or physical location information about the translation servers and comparing the location information about the translation servers with location information about the translation system.

8. A machine translation method, comprising:
receiving source language data;
determining in which of one or more translation sections of a terminal to perform translation processing or determining whether to delegate translation processing to one or more translation servers through a communication line;
based on the determination, performing the translation processing of the source language data on the terminal, or delegating the translation processing of the source language data to the translation servers and receiving a result; and
outputting target language data as a translation result.

9. The machine translation method of claim 8, wherein
information about a language pair to which translation is applied is used in determining in which of the translation sections of the terminal to perform the translation processing or determining whether to delegate the translation processing to the translation servers through the communication line.

10. The machine translation method of claim 8, wherein
information about a communication state between the terminal and the translation servers is used in determining in which of the translation sections of the terminal to perform the translation processing or determining whether to delegate the translation processing to the translation servers through the communication line.

11. A machine translation method, comprising:
receiving source language data;
determining whether to perform translation processing on a terminal or determining to which of a plurality of external translation servers connected through a communication path to delegate translation processing;
based on the determination, performing the translation processing on the terminal, or delegating the translation processing of the source language data to one of the external translation servers and receiving a result; and
outputting target language data as a translation result.

12. A machine translation method, comprising:
receiving source language data;
requesting and obtaining translation server information from one or more translation servers;
based on the obtained translation server information, determining whether to perform translation processing on a terminal or determining to which of the translation servers connected through a communication line to delegate translation processing;
based on the determination, performing the translation processing on the terminal, or delegating the translation processing of the source language data to one of the external translation servers and receiving a result; and outputting target language data as a translation result.

13. The machine translation method of claim 12, comprising
requesting and obtaining information from one or more of the translation servers about one or more of a supported translation language pair, a cost, a translation quality, and a supported domain, and using the information to determine where to perform the translation processing.

14. The machine translation method of claim 12, comprising
requesting and obtaining network or physical location information from the external translation servers and comparing the location information with location information about the terminal to determine where to perform the translation processing.

15. A signal bearing medium tangibly embodying a node program of machine-readable instructions executable by digital processing apparatus, comprising the processing of:
receiving source language data;
determining whether to perform translation processing on a terminal or to delegate translation processing to a translation server through a communication line;
based on the determination, performing the translation processing of the source language data in one or more translation sections of the terminal, or delegating the translation processing of the source language data to the translation server and receiving a result; and
outputting target language data as a translation result.

16. The medium of claim 15, comprising the processing of
causing a computer to use information about a language pair to which translation is applied and determine whether to perform the translation processing on the terminal or to delegate the translation processing to the translation server through the communication line.

17. The medium of claim 15, comprising the processing of
using information about a communication state between the terminal and the translation server to determine whether to perform the translation processing on the terminal or to delegate the translation processing to the translation server through the communication line.

18. A signal bearing medium tangibly embodying a node program of machine-readable instructions executable by digital processing apparatus, comprising the processing of:
receiving source language data;
determining whether to perform translation processing on a terminal or to delegate translation processing to any of a plurality of translation servers connected through a communication path;
based on the determination, performing the translation processing on the terminal, or delegating the translation processing of the source language data to one of the translation servers and receiving a result; and
outputting target language data as a translation result.

19. A signal bearing medium tangibly embodying a node program of machine-readable instructions executable by digital processing apparatus, comprising the processing of:
receiving source language data;
requesting and obtaining translation server information from a plurality of translation servers;
based on the translation server information obtained from the translation servers in the requesting and obtaining processing, determining whether to perform translation processing on a terminator determining to which of the translation servers connected through a communication line to delegate translation processing;
based on the determination, performing the translation processing on the terminal, or delegating the translation processing of the source language data to one of the translation servers and receiving a result; and
outputting target language data as a translation result.

20. The medium of claim 19, comprising the processing of
requesting and obtaining translation server information from the translation servers about one or more of a, supported translation language pair, a cost, a translation quality, and a supported domain, and using the translation server information to determine where to perform the translation processing.

21. The medium of claim 19, comprising the processing of
requesting and obtaining network or physical location information from the translation servers and comparing the information with location information about the terminal to determine where to perform the translation processing.

22. A translation communication system, comprising:
one or more translation servers with a communication line;
a translation section that performs translation processing between languages;
a communication control section that controls communication with the translation servers through the communication line; and
a translation means determination section that determines whether to perform translation processing in the translation section or to delegate translation processing to the translation servers through the communication control section.
